(19) United States
(12) Patent Application Publication
(10) Pub. No.: US 2007/0271106 A1
(43) Pub. Date: Nov. 22, 2007

(54) SYSTEM AND METHOD FOR SECURE INTERNET CHANNELING AGENT

(76) Inventors: David Hee-Don Lee, Alexandria, VA (US); John JeongHo Park, Alexandria, VA (US)

Correspondence Address: DAVID H. LEE, 6606 SCHURTZ ST., ALEXANDRIA, VA, 22310, US

(21) Appl. No.: 11/419,244

(22) Filed: May 19, 2006

(51) Int. Cl. G06Q 10/00; H04L 9/00; G06F 17/00

(52) U.S. Cl. 705/1; 726/1

(57) ABSTRACT

A system and method for establishing a Secure Internet Channeling Agent (SICHA), a third party trusted authorized channeling agent, making direct, secure, and fast Internet channeling between a user device and a media content server. In the preferred embodiment, the SICHA directly relays user's channeling request to the media content server with user's reserved channeling socket information for the fast channeling. At the same time, the SICHA generates and transmits one-time symmetric secure channel keys to both of the media content server and the user device to encrypt and decrypt media content stream. The encrypted media content stream is transmitted to the user device through a virtually dedicated UDP channel. Finally, the SICHA also relayed channel ending message when the user device request.

### CROSS-REFERENCE TO RELATED APPLICATIONS

The present application is related to the following application: U.S. patent application Ser. No. 11/164,082 filed Nov. 9, 2005.

### TECHNICAL FIELD

The present invention is generally related to the field of Web searching or hosting service site to find media content streaming. More particularly, the present invention is related to a system and method for searching media content through a virtually dedicated secure Internet channel provided by a third party trusted authorized agent.

### BACKGROUND OF THE RELATED ART

In recent years, the demand of Internet media searching and hosting with all types of digital media, such as picture, audio, video, and other media data, has grown exponentially in popularity. Also, the media searching and hosting method via Internet is quickly replacing the conventional media broadcast method, such as TV and radio. The Internet media searching and hosting has great potential because it collects and delivers diverse media content to users. In addition, a user can render the media content from anywhere only if the user has a device that connects to Internet service. However, the internet media searching and hosting service has lack of fast access process, computer or network security, and media content filtering.

There are three existing prototypes of Internet media searching and hosting method; an Individual Internet Media Access model, a Media Searching Directory model, and a Central Media Hosting model.

With the Individual Internet Media Access model, an Internet user simply inputs the URL of a media provider on a Web browser, and access directly into the media provider's media content. The concept of the DNS name translation process is not mentioned here since it is same as all other models. The advantage of this model is that a user connects and gets media content stream very fast only if the user already knows the media provider's content information. However, there are several drawbacks since the Individual Internet Media Access model uses direct connection method between a user and a media provider getting media content stream. First, there is lack of various media content because a user only accesses the media provider that the user already knows. Second, there is lack of computer security protection both of users and media providers unless the media provider is a proven trusted party. At the same time, while users don't know how secure the media content is, the media providers also need secure method to protect their media property such as DRM content protection method. Third, the media content should be controlled and managed to provide high quality of broadcast service to media users.

The Media Searching Directory, as the second prototype of Internet media searching and hosting method, searches the entire Internet to get various media content as a search result. The users get the link information from the search engine and request media content to a media provider directly. Most media searches are done by looking for words in media's title text, or metadata in descriptions embedded in a media file. The metadata are kind of tags such as embedded title or artist and album information in a media file. Therefore, the advantage of this model is that the resource of media content is various since the Media Searching Directory gathers and links diverse media content of media servers. Also, the Media Searching Directory classifies and manages the information of the media content under the media searching directory.

There are several defects for using the Media Searching Directory model though. First, there is lack of good security method for protecting both of users and media providers. Even though the Media Searching Directory provides trustworthy link information of media providers, users are not convinced about how secure the media content is. Also, the media providers don't want for any user accesses to their media content without secure content protection method. Second, it is hard for the Media Searching Directory to filter media stream to manage and control the content. Third, the accessing time of the Media Searching Directory model is relatively longer than the accessing time of the Individual Internet Media Access Model because a user initially has to get media link information from the directory service. Forth, the transmitting speed of media stream is not constant since Media Searching Directory doesn't affect to each media provider.

The third type of Internet media searching and hosting prototype is a Central Media Hosting model which also performs media searches, but searches only among the material it hosts on its own servers. This service model doesn't search across the entire Web. The servers of the service model store media content either from media providers or from members in advance and send it to users when the media content is requested. This model transmitting media content stream either by using a media player or by transforming media signal to IP format. The Central Media Hosting model has several strongpoints to deliver the media content stream. First, the dedicated system of the Central Media Hosting model is able to protect media content employing unique security method. Second, the dedicated filtering system controls and manages the same type of media content stream. Third, the transmitting speed of media content stream is constant and reliable because the dedicated system of Central Media Hosting model employs unique media relay method for media content.

However, there are still some weaknesses to provide media content stream in the Internet. One is that the dedicated system of Central Media Hosting model bears the burden of heavy network load since the system receives all media content from media providers and relays it to users. The other one is that the resource of media content is relatively limited because the dedicated system of Central Media Hosting model only relays the media content which is provided from media servers.

### SUMMARY OF THE INVENTION

The present invention is a system and method for establishing a Secure Internet Channeling Agent (SICHA), a third party trusted channeling agent, making direct, secure, and fast Internet media connection between a user device and a media content server. This model is neither the Media Searching Directory model nor the Central Media Hosting model. In the SICHA's database, it reserves channeling socket information consisting of the user's IP address and a UDP port for an initial stage. When the user requests one of the media content, the SICHA doesn't reply the media searching information, but directly relays the user's media request to the media content server as a channel. For the fast media channeling, the SICHA relays the user's media request with user's reserved channeling socket information to the media content server. At the same time, the SICHA generates and sends one-time symmetric channel keys to both of the media content server and the user device. Since the media content server knows a user's reserved channeling socket information from the SICHA, the media content server is able to start to transmit the media content stream encrypted by the channel key to the user through a virtually dedicated UDP channel. A user's device starts to decrypt the encrypted UDP content stream by using the symmetric channel key received by the SICHA.

In another aspect, the SICHA provides the private Channel Name System (CNS) for a media community or a region on the basis of the public Domain Name System (DNS). Using the protocol of CNS, a media provider can make multiple private channel names without disrupting its public domain name. While the existing public DNS has limited domain name for the system, the private CNS allows the media providers to employ as many media domain name as they could without conflicting other domain names.

With the SICHA, the user accesses directly to various Intent media providers containing diverse media content since the system includes the media domain name translation service for media content group or media content server. The SICHA protects media content with a couple of symmetric channel keys to encrypt and decrypt the content from a media provider to a user. Also the system establishes a virtually dedicated UDP channel with a reserved socket including user's IP and a reserved UDP port, so the transmitting time of media stream is shorter than the other models.

Other systems, methods, features and advantages of the invention will be apparent to one with skill in the art upon examination of the following figures and detailed descriptions, and claims provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram of method and system of a secure Internet channeling agent (SICHA) in accordance with an embodiment of the present invention.

FIG. 2 is a sequential chart depicting method and system of a SICHA in accordance with an embodiment of the present invention.

FIG. 3 is a block diagram of detailed method and system of a SICHA including database relational diagram in accordance with an embodiment of the present invention.

FIG. 4 is a logical flow diagram that depicts the operations which are performed by a SICHA communicating with a user device and a media content server in accordance with an embodiment of the present invention.

FIG. 5 is a logical flow diagram that depicts the operations which are performed by a media content server communicating with a SICHA and a user device in accordance with an embodiment of the present invention.

FIG. 6 is a logical flow diagram that depicts the operations which are performed by a user device communicating with a SICHA and a media content server in accordance with an embodiment of the present invention.

### DETAILED DESCRIPTION OF THE PREFERRED EMBODIMENT

Reference will now be made in detail to the embodiments of the present invention, example of which are illustrated in the accompanying drawings.

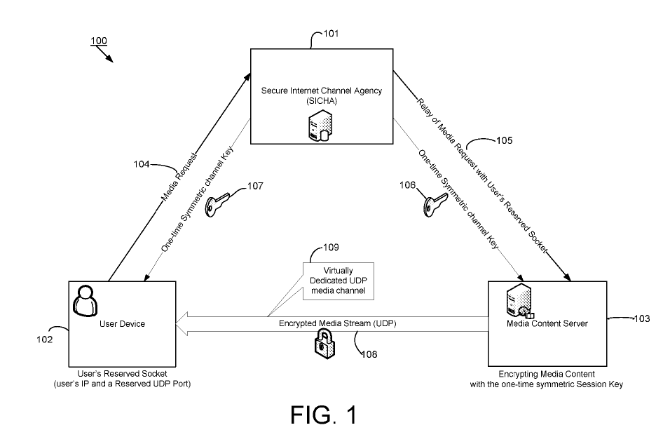

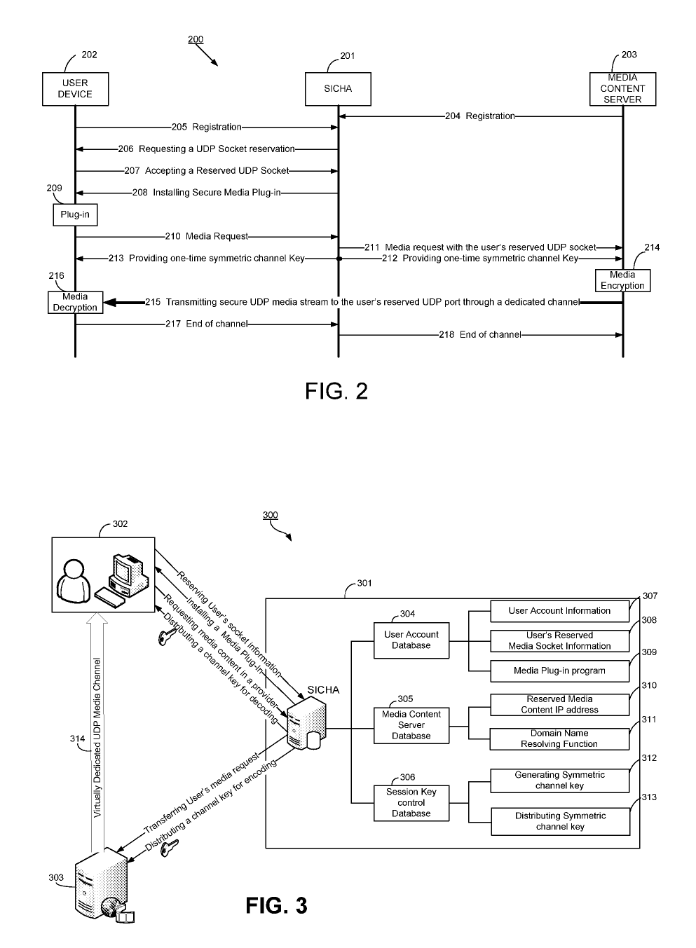

FIG. 1 illustrates a block diagram 100 of method and system of a secure Internet channeling agent (SICHA) 101. The SICHA 101 is a third party trusted authorized channeling agent which directly connects both of a user device 102 and media content server 103 in a secure, reliable, and fast way. As described in further detail below and illustrated in FIG. 2, a sequential chart 200 depicting work-flow of the present invention, the SICHA 201 works as a mediator providing direct and secure Internet channeling between a user device 202 and a media content server 203. The user device 102 and 202 can be desktop computers, laptop computers, handheld devices, or like devices. Media content may include picture, audio, video, and other media data. As shown in FIG. 2, the SICHA 201 in the preferred embodiment performs many functions between a user device 202 and a media content server 203. For the initial stage, the SICHA collects or receives reservation information 204 of the source address of the media content server 203 or the group of media content in the media content server 203. The group of media content means for TV, radio, movie and music files. For the next step, an Internet user registers an account 205 for its device 202 to the SICHA's database for reaching the media content. When the SICHA 201 receives user's registration, it requests the reserved socket information 206 of the user device 202 to set it up. The user socket information consists of an IP address and a virtually dedicated UDP port number. When the user device 202 sends a reserved socket information message to the SICHA, the SICHA 201 accepts the reserved socket 207 for transmitting media stream from a media content server 203 to the user's device 202. Using the reserved socket, a media content server 203 can transmit the media stream through a virtually dedicated UDP channel. As soon as the SICHA 201 receives user's channeling socket information, it stores the information in its database and transmits a secure channeling plug-in program 209 to use channeling protocol for the user device 202 to install the secure channeling plug-in program 208. Right after the user installs the secure channeling plug-in program 209 into the user device, the user can use the channeling protocol for accessing to media content. In this point, SICHA system ends the initial stage and is ready to start for a normal stage. For the normal stage, the user device requests 210 media content or media content group of a media server to the SICHA through the secure channeling plug-in program. The SICHA, as a channeling request relay agent, relays 211 the media content request to the media content server with the requested user's reserved UDP socket information. For the secure media content protection method, the SICHA generates a pair of one-time symmetric channel key, and provides 212 and 213 each key to both of the media content server and the user device. Then, the media content server encrypts the media content stream 214, that the user device requested, with the one-time symmetric channel key. As soon as the server encrypts the media content stream, the media content server starts to transmit 215 secure UDP media stream to the user's reserved UDP port through a virtually dedicated channel. When the user device receives the secure UDP media stream, the user device decrypts 216 the encrypted media content stream using one-time symmetric channel key, which was sent by the SICHA. For the channel end, the requesting process is the same as the previous channeling request method. The user device notices channel end 217 to the SICHA, and the SICHA relays the channel end message 218 to the media content server. Then, the media content server stops transmitting the secure UDP media stream to the user device.

FIG. 1 mainly describes how SICHA 101 works with the user device 102 and the media content server 103 for transmitting media content through Internet after the initial stage. Since the user reserved an account in SICHA and installed the plug-in program, the user's device requests 104 media content of the media content server 103 to the SICHA 101 using channeling protocol. The media content could be a group of media content such as TV, radio, video, music etc. As soon as the user requests the media content, SICHA directly relays 105 the request to the media content server with user's reserved channeling socket information. Generally, the existing system of Media Link Directory model simply provides the IP address of the media content server to a user while the existing system of Central Media Relay model stores media content and relays the media content from the server to the user. However, the SICHA directly relays the media content request to the media content server, and let the server provides media content stream to the user device. The media content server transmits UDP media stream into the user's device using the reserved socket. After setting up the link between the user and the server, the media stream is transmitted 108 through a virtually dedicated the UDP channel 109. In this process, the media content server uses UDP packet instead of TCP packet because the transmission speed of UDP is much faster than the speed of TCP. The UDP packet transmission is suitable for the media content stream even though TCP is more reliable than UDP.

The other function of the SICHA is generating one-time symmetric channel keys 106 and 107 and encrypting/decrypting the media content stream. In FIG. 1, the SICHA, as the trusted third party as an authorized channeling agent, generates a pair of symmetric channel key, and distributes it 106 and 107 to both of the user and the media content server. The server uses it for encrypting UDP media stream, and the user employs it for decrypting the transmitted media stream during the same channel. Since the symmetric channel key is one-time temporary secure code, it is disposable after the channel is ending. The SICHA regenerates another pair of symmetric keys for new channel to both user device and media content server. The media content server encrypts UDP media stream with the channel key and transmits it 108 to the user's reserved channeling socket. The user waits for encrypted media stream from the media content server after it receives and sets up the symmetric channel key into the plug-in program. When the encrypted UDP media stream is arrived at the user's UDP port, user decrypts it with the symmetric channel key. Since the symmetric channel key is used for decrypting the media content stream, the media stream can be transmitted very securely through a virtually dedicated UDP channel between the user and the media content server.

For the channel ending, the user requests channel ending message to the SICHA. As soon as the SICHA receives the channel ending request message from the user, it relays the message to the media content server. The server ceases the UDP media content stream through the reserved socket of the user device when the server received the channel ending message.

FIG. 3 describes a block diagram 300 of detailed method and system of a SICHA 301 including database relational diagram when it communicates with either a user device 302 or a media content server 303. In the SICHA 301, there are three main databases which are a user account database 304, media content server database 305, a channel key control database 306. First, the user account database 304 manages user's account information 307, user's reserved channeling socket information 308, and a channeling plug-in program 309. The SICHA 301, as a third party trusted authorized channeling agent, gives media content access right to a trusted based customers only. In that way, the SICHA securely relays any channeling request to media content server 303, and distributes the one-time symmetric channel key information to the user. SICHA could use the user's account information for a channeling payment transaction if it served paid channeling service. Also, both of the SICHA and a user agree a reserved channeling socket and store the information into the user account database in the SICHA. The channeling socket consists of an IP address and a UDP port number of the user device 302. The UDP port number of the user device could be assigned by the SICHA or the user. If the UDP port number assigned by the SICHA, it could be a virtually dedicated SICHA port for transmitting media content stream. Therefore, the media content server transmits UDP media stream to the user device through virtually dedicated UDP channel 314.

Second, the media content server database 305 controls 310 the source address of reserved media content server 303 and channel name resolving function 311. As an initial stage, the media content server reserved its media content to the database of the SICHA to participate the channel providing service. The server could reserve source address of either server itself or group of media content. The other function of the media content server database is domain name resolving method. When a user request one of the media channel name, the media content server database acts as a domain name resolving mode. The difference with public DNS is the database translates the domain name to an source address form, and then uses the source address to relay user's media content request to the media server.

Third, the channel key control database 306 generates 312 and distributes 313 secure symmetric channel key. The generator continuously creates one-time symmetric channel keys combined by random numbers. The distributor delivers the channel keys both of a user device and a media content server.

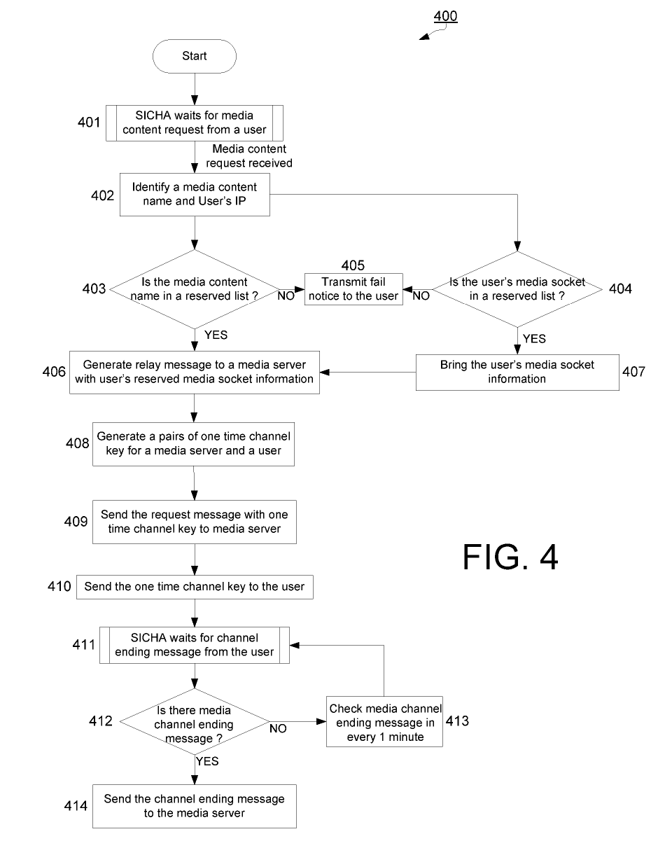

FIG. 4 shows a logical flow diagram 400 of the SICHA during a normal channel. When it starts, the SICHA stays a wait mode for the media content request from a user 401. Whenever the SICHA receives the media content request from the user, it checks both of a media content server database and a user account database 402. First of all, the SICHA compares the media content name to the server database 403. When the names are match each other, the database translates the media content name to a source address as a public DNS works. If the names do not match together, the SICHA transmits failure notice to the user 405. At the same time, the SICHA checks whether there is user's reserved channeling socket information in a user account database or not 404. If there is the channeling socket information, the SICHA brings it to the channeling request process. Otherwise the SICHA transmits failure notice to the user as well 405. The SICHA creates relay message 406 adding user's reserved socket information 407 to the media content server. The SICHA also generates pairs of one-time symmetric channel key for the media content server and the user 408. The SICHA initially relays the media content request message with an one-time symmetric channel key to the media server 409. At the same time, it sends the one-time symmetric channel key to the user device 410. In this step, the SICHA has done its work for relaying user's media content request to the server except for channel ending. Therefore, the SICHA waits for user's request of channel ending message 411. When it receives the channel ending message from the user 412, it also relays user's ending message to the media content server 414. Otherwise, the SICHA checks channel ending message in every 1 minute 413, and the process loops until the SICHA gets the channel ending message from the user device.

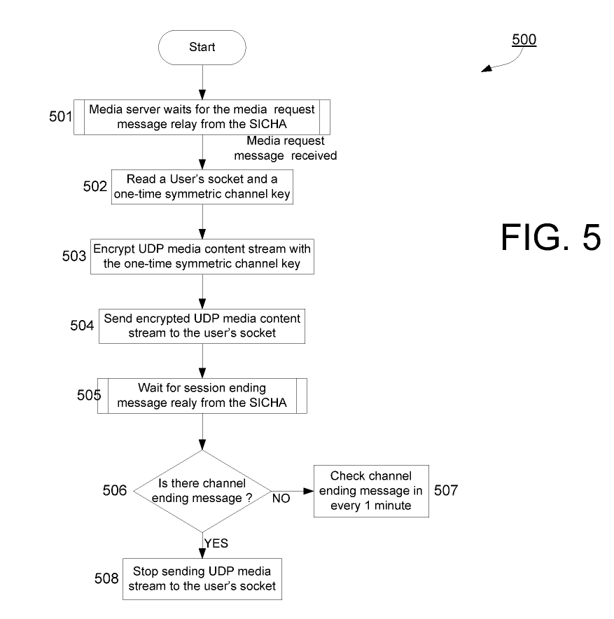

FIG. 5 describes a logical flow diagram 500 of a media content server working with the SICHA and the user device. For the start, the media content server waits for the channeling request message relay from the SICHA 501. When the media content server receives the channeling request message relay, it reads a user's socket information and a one-time symmetric channel key 502. The server encrypts UDP format media content stream with the one-time symmetric channel key 503. Since the server knows the user's socket information, it sends the encrypted UDP media content stream to the user device with the reserved port 504. After it starts to send media content stream, the server waits for channel ending message relay from the SICHA 505. If there is channel ending message relay from the SICHA 506, the server stops sending the UDP media content stream to the user's socket 508. If there is no channel ending message relay 506, the server checks the channel ending in every 1 minute 507, and the process loops until the server gets the channel ending message relay from the SICHA.

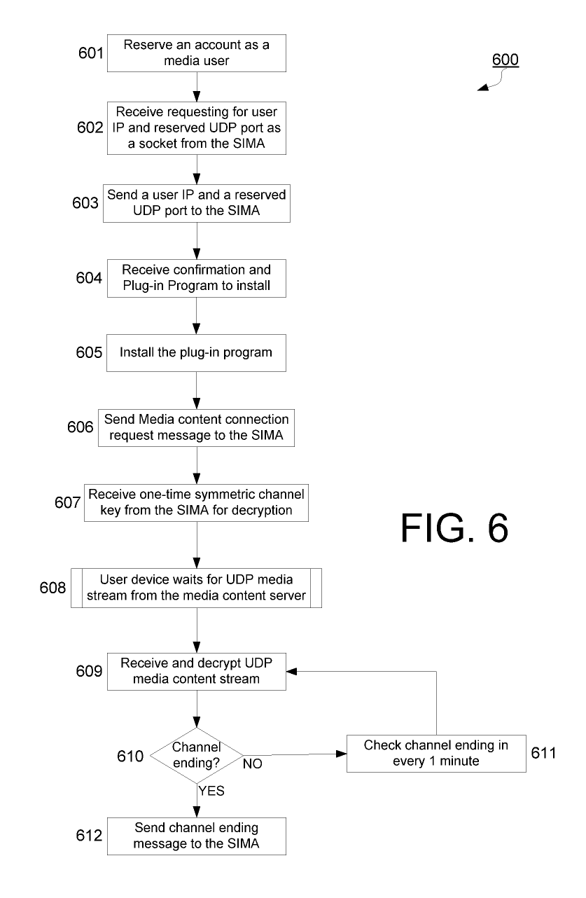

FIG. 6 describes a logical flow diagram 600 of a user device working with the SICHA and the media content server. The process initially starts with reservation of an account as a media user into the SICHA 601. The response of the reservation from the SICHA includes a request of a user IP and a reserved UDP port of the user device as socket information 602. The user device transmits and informs the user IP and the virtually dedicated UDP port to the SICHA 603. The SICHA sends confirmation message and plug-in program to the user device 604. Then, the user device installs the plug-in program 605. After the initial stage, the user device enters channeling request message to the SICHA 606. For the response from the SICHA, the user device receives the one-time symmetric channel key for decryption 607. And then, the user device waits for UDP media content stream from the media content server 608. When the user device receives the UDP media content stream from the media content server, it decrypts the encrypted secure UDP media stream 609. Also, whenever the user device wants to cease the channel 610, it transmits the channel ending message to the SICHA 612. Otherwise it checks channel ending in every one minute 611.

While various embodiments of the present invention have been described above, it should be understood that they have been presented by way of example, and not limitation. It will be apparent to persons skilled in the relevant art that various changes in form and detail can be made therein without departing from the spirit and scope of the invention.

What is claimed is:

1. A system and method for establishing a secure Internet channeling agent having direct and secure Internet channeling between a user device and a media content server, said system and method comprising:
storing a reserved media content source address in the secure Internet channeling agent from one of the media content servers for an initial stage, wherein the reserved media content source address is assigned on files of the media content servers;
storing reserved channeling socket information to the secure Internet channeling agent from one of the user devices for an initial stage, wherein the reserved channeling socket information consists of a user IP and a virtually dedicated UDP port;
receiving a channeling request message from the user device at the secure Internet channeling agent, wherein the media content request message comprises a media content domain name to be translated to the reserved media content source address;
generating one-time symmetric channel encryption and decryption keys in the secure Internet channeling agent for both of the media content server and the user device;
relaying the channeling request message to the media content server, wherein the secure Internet channeling agent attaches the reserved channeling socket information and the one-time symmetric channel encryption key in the channeling request message;
sending the one-time symmetric channel decryption key from the secure Internet channeling agent to the user device, wherein the user device decrypts the encrypted media content stream from the media content server;
transmitting the requested media content stream in UDP packet format from the media content server to the user device, wherein the requested media content stream is sent to the reserved channeling socket of the user device; and
relaying the channel ending message from the user device to the media content server to cease transmitting the requested media content stream.

2. The system and method of claim 1, wherein the secure Internet channeling agent means for the trusted third party as an authorized channeling agent.

3. The system and method of claim 1, wherein the secure Internet channeling agent has three role consisting translation of domain names, relaying trusted channeling request, generation and distribution of one-time symmetric channel key for encryption and decryption.

4. The system and method of claim 1, wherein the secure Internet channeling agent consists of a user account database, a media content server database, and a channel key control database.

5. The method of claim 4, wherein the user account database stores user account information and user's reserved channeling socket information, and provides channeling plug-in program.

6. The method of claim 4, wherein the media content server database provides a reserved media content source address and domain name translation function.

7. The method of claim 4, wherein the channel key control database generates and distributes one-time symmetric channel encryption and decryption keys.

8. The system and method of claim 1, wherein the user device comprises a desktop computer, a laptop computer, a handheld device, and a mobile phone.

9. The system and method of claim 1, wherein the media content comprises picture, audio, video, and other media data.

10. The system and method of claim 1, wherein the group of media content comprises TV, radio, movie, and music.

11. The system and method of claim 1, further comprising:
sending from the secure Internet channeling agent to a user device a plug-in program to recognize a channeling request protocol; and
installing the plug-in program into the user device.

12. The plug-in program embodied on the user device of claim 11, further comprising:
entering a desired media domain name in the address text field of user interface; and
sending the desired media domain name to the secure Internet channeling agent.

13. The transmitting method to the reserved channeling socket of the user device of claim 1, wherein the requested media content stream is sent through a virtually dedicated UDP channel.

14. The method of relaying the channel ending message of claim 1, wherein the secure Internet channeling agent checks the channel ending message in every one minute.

15. The method of checking the channel ending message of claim 14, wherein the secure Internet channeling agent let the media content server stop sending UDP media content stream to the user's socket.
